(19) United States
(12) Patent Application Publication
(10) Pub. No.: US 2011/0147081 A1
(43) Pub. Date: Jun. 23, 2011

(54) Cable Gland

(76) Inventor: Dieter Best, Ingelfingen (DE)

(21) Appl. No.: 12/816,421

(22) Filed: Jun. 16, 2010

(30) Foreign Application Priority Data
Jun. 16, 2009 (EP) 09162864.4

(51) Int. Cl. H02G 3/06

(52) U.S. Cl. 174/84 R

(57) ABSTRACT

The present invention relates to a cable gland for an electronics housing (6) of an electric motor, comprising a cable adapter (1) and a screw-on connecting stub (2), which can be screwed to a housing, for attachment of a cable connection. Fixing means (3, 2.8) which are arranged on the cable adapter (1) and on the screw-on connecting stub, allowing, in an assembly position, an axial insertion of the cable adapter (1) into the screw-on connecting stub (2) in any desired rotation position relative to one another and in an inserted state, allowing alignment of the rotation position of the cable adapter (1) relative to the screw-on connecting stub (2) and in a fixing position, fixing the cable adapter (1) axially and in the respective relative rotation position to the screw-on connecting stub (2).

### CROSS REFERENCE TO RELATED APPLICATION

This application claims priority to European Patent Application No. 0 916 2864.4, filed Jun. 16, 2009.

### FIELD OF THE INVENTION

The subject matter of the invention is a cable gland for an electronics housing of an electric motor having a through-opening, comprising a cable adapter and a screw-on connecting stub for attaching a cable connection to a housing, for example for attaching a cable harness to an electronics housing of an electric motor. The invention likewise includes an electronics housing of an electric motor having a cable gland such as this.

### BACKGROUND AND SUMMARY OF THE INVENTION

A cable gland such as this is already known from the document DE 9406382 U1. In this cable gland, two parts which can rotate with respect to one another, a cable adapter and a screw-on connecting stub, are fixed axially by snap-action or latching connections and are fixed in a predetermined rotation position by a latching device. One disadvantage of this embodiment is that the rotation position is predetermined by the latching device. A second disadvantage is that the cable gland must be rotated for fixing. Depending on the spatial circumstances in the vehicle and on the alignment of the cable connection and the position of the housing, these disadvantages can make the fitting process more difficult. In addition, an embodiment such as this with a latching connection can be released only with difficulty, and can be damaged while being released. Furthermore, the length of the housing-side part is lengthened by a hexagon which is fitted on the external circumference and acts as a tool action point for screwing the screw-on connecting stub to the housing, and this can likewise have a disadvantageous effect on the fitting process, for space reasons.

In one known electronics housing for an electric motor, for example as described in DE 103 13 274 A1, the electronics housing has an opening for the electrical connection, which opening can be closed in a sealed manner by a connecting plug connector which is connected to external connecting lines.

The present invention is based on the object of avoiding the disadvantages described above and of designing a cable gland of the type described initially such that there is no restriction to the capability to rotate, the cable gland can be fixed in any desired rotation position, the connection can be released easily and without damage, and the length of the cable gland is at the same time kept short. A further object of the invention is to allow prefabrication of the cable connection.

According to the invention, this is achieved by fixing means which are arranged on the cable adapter and the screw-on connecting stub, which allow, in an assembly position, an axial insertion of the cable adapter into the screw-on connecting stub in any desired rotation position relative to one another and, in an inserted state, allow any desired alignment of the rotation position of the cable adapter relative to the screw-on connecting stub and, in a fixing position, fix the cable adapter axially and in the respective rotation position to the screw-on connecting stub.

In this case, it is advantageous for the cable adapter to have a plug-in connecting stub for the mounting position, which has a snap-action depression which runs on its external circumference and, on the side of its insertion opening, the screw-on connecting stub has a plurality of radically elastic snap-action arms, which are distributed on its circumference, as fixing means, which snap-action arms engage in the snap-action depression when the plug-in connecting stub is in the completely inserted state, and produce an axial interlocking connection between the plug-in connecting stub and the snap-action arms. This has the advantage that the cable adapter can be inserted into the screw-on connecting stub in any desired rotation position, and that the rotation position can also be aligned as required after insertion.

A further advantage is that a union nut for the fixing position is in the form of additional fixing means, which is pushed onto the plug-in connecting stub and is screwed on by means of a tightening thread on the screw-on connecting stub, which tightening thread is located behind the snap-action arms in the screwing-on direction, and produces an axial interlocking connection and an interlocking connection which counteracts the rotation, between the plug-in connecting stub and the snap-action arms of the screw-on connecting stub, by means of an internal clamping surface of the union nut, which clamping surface tapers conically in the opposite direction to the screwing on direction. This has the advantage that the cable adapter can be fixed in any desired rotation position without additional twisting. This fixing has the further advantage that it is based on a interlocking connection, which can easily be released, between the union nut, the clamping arms of the screw-on connecting stub and the clamping depression in the plug-in connecting stub, and can therefore be released without damaging the snap-action arms or the snap-action depression.

The present invention also has the advantage of allowing the screw-on connecting stud to be shortened in that the screw-on connecting stub is provided on its internal circumference of the through-opening in the area of the screw-on thread with an internal polygonal contour as an internal force action point, which allows the screw-on connecting stub to be screwed in, gripping from the inside, using a normal hexagonal wrench.

The cable gland according to the invention is advantageously produced from plastic.

Further advantageous refinement features of the invention are contained in the dependent claims and in the following description.

### BRIEF DESCRIPTION OF THE DRAWINGS

The invention will be explained in more detail with reference to exemplary embodiments which are illustrated in the attached drawings, in which:

FIG. 1 shows an exploded illustration of one exemplary embodiment of a cable gland according to the invention,

FIG. 2 shows an axial cross section through one exemplary embodiment of a cable gland according to the invention which has been plugged together and fixed,

FIG. 3 shows an axial cross section through a further exemplary embodiment of a cable gland according to the invention,

FIG. 4 shows an axial cross section through a sub area of an electronics housing with a screw-on connecting stub fitted,

FIG. 5 shows a detail of a three-dimensional view of an electric motor with electronics housing having a cable gland according to the invention, without connecting lines,

FIG. 6 shows a three-dimensional view of a ventilation unit with an electric motor having electronics housing with a cable gland according to the invention, as shown in the exemplary embodiment in FIG. 3,

FIG. 7 shows a cross section through a detail of an electronics housing with a screwed-in cable gland according to the invention.

### DETAILED DESCRIPTION OF THE INVENTION

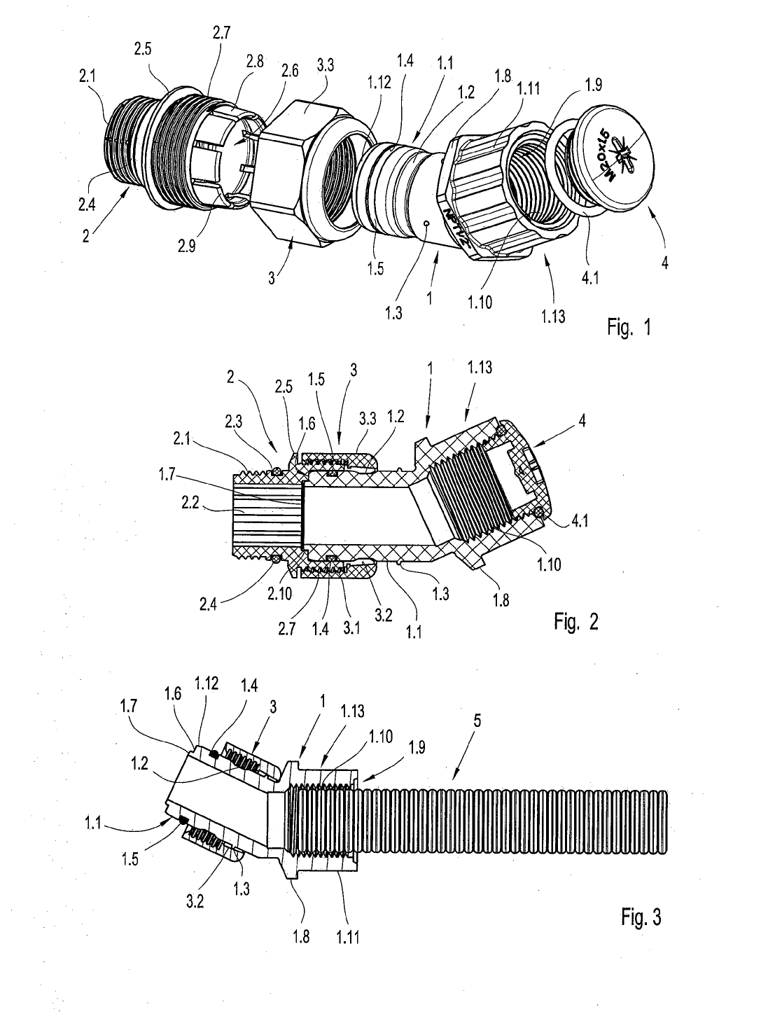

The same parts are identified by the same reference symbols in FIGS. 1 to 7.

By way of example, FIG. 1 and FIG. 2 show a cable gland according to the invention which comprises a cable adapter 1, a screw-in connecting stub 2, a union nut 3, a closure screw 4 and a plurality of O-ring seals 1.5, 2.4, 4.1.

The screw-in connecting stub 2 is hollow-cylindrical and has two housing sections which are split by a contact wall 2.5, which runs on the external circumference, and have a through-opening. In the housing section facing away from the cable adapter 1, the screw-on connecting stub 2 has a screw-on thread 2.1 on its external circumference and, between the screw-on thread 2.1 and the contact wall 2.5, it has a circumferential groove 2.3 with an O-ring seal 2.4. The O-ring seal 2.4 seals the connection between the screw-on connecting stub 2 and an attachment housing which is not illustrated. In addition, an internal polygonal contour 2.2 is located on the internal circumference of the through-opening in the area of the screw-on thread 2.1 and is used as an internal force action point for screwing the screw-on connecting stub 2 into the attachment housing by means of a polygonal wrench. In the housing section facing the cable adapter 1, the screw-on connecting stub 2 has a plurality of radially elastic snap-action arms 2.8, which are distributed over its external circumference, are in the form of circumferential segments separated by a gap and taper conically toward the insertion opening 2.6, and have chamfers 2.9 at the end on their inner and outer faces. A tightening thread 2.7 is located on the external circumference between the snap-action arms 2.8 and the contact wall 2.5 of the screw-on connecting stub 2. A centering depression 2.10 is additionally located at the inner end of the insertion opening 2.6, which centering depression 2.10 runs over the internal circumference and centers the cable adapter 1 in the insertion opening 2.6 once it has been inserted completely.

The cable adapter 1 is likewise hollow-cylindrical and has two housing sections, which are split by an external hexagon 1.8 which runs on the external circumference, and have a through-opening. In the housing section facing the screw-on connecting stub 2, the cable adapter 1 has a plug-in connecting stub 1.1. At its end facing the screw-on connecting stub 2, the plug-in connecting stub 1.1 has a conically tapering chamfer 1.12 on the circumference and, on its end surface, it has a centering attachment 1.7. In addition, the plug-in connecting stub 1.1 has a snap-action depression 1.2, which runs on its external circumference, and a circumferential groove 1.4 with an O-ring seal 1.5 between the snap-action depression 1.2 and the chamfer 1.12. The O-ring seal 1.5 seals the connection between the screw-on connecting stub 2 and the cable adapter 1. In addition, two holding studs 1.3 are located between the snap-action depression 1.2 and the external hexagon 1.8 on the external circumference of the plug-in connecting stub 1.1, which holding studs 1.3 have end areas which can be deformed elastically in the axial direction of the plug-in connecting stub 1.1 and, when not inserted, secure the union nut 3 against sliding down from the plug-in connecting stub 1.1, by means of a interlocking connection to the clamping surface 3.2 of the union nut 3. In the housing section facing away from the screw-on connecting stub 2, the cable adapter 1 has a cable holding stub 1.13. At its end facing away from the screw-on connecting stub 2, the cable holding stub 1.13 has a cable connecting opening 1.9 with an internal thread 1.10, which runs in its internal circumference, and, on its external circumference, it has a plurality of action-point depressions 1.11, which run axially and are distributed over the circumference. The axes of the plug-in connecting stub 1.1 and of the cable holding stub 1.13 include an angle α≦180°, preferably an obtuse angle.

On the side facing the screw-on connecting stub 2, the union nut 3 has a tightening thread 3.1, which runs in the internal circumference, and an external hexagon 3.3 which runs on its external circumference. On the side of the internal circumference facing away from the screw-on connecting stub 2, there is a conically tapering clamping surface 3.2. The external hexagon 3.3 is used as a force action point for a tightening tool, which is not illustrated, in order to screw the union nut 3 onto the tightening thread 2.7 on the screw-on connecting stub 2, by means of the tightening thread 3.1 on the union nut 3.

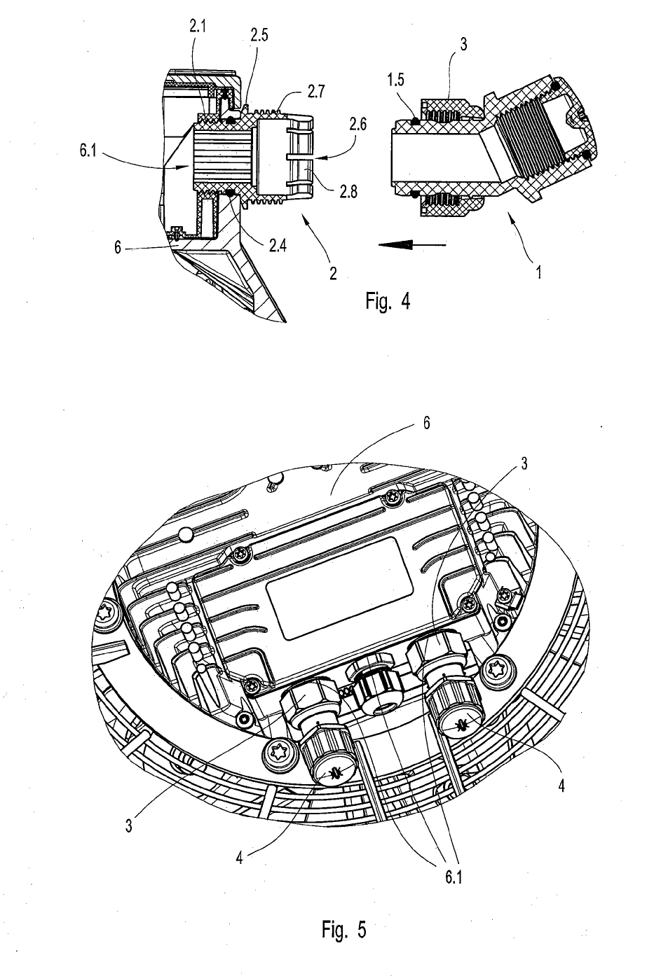

As is shown in FIG. 4, the cable gland according to the invention as illustrated in FIGS. 1 and 2 is fitted to an electronics housing 6 of, for example, an electric motor which is not annotated in any more detail. The electronics housing 6 has at least one screw-on opening 6.1, which is provided with an internal thread and into which the screw-on connecting stub 2 is screwed. The O-ring seal 2.4 already mentioned above is used to seal the screw-on connecting stub 2. The screw-on connecting stub is in this way fixed to the electronics housing 6.

The rest of the process of assembling the cable gland according to the invention is then carried out by attaching the cable adapter 1 to the screw-on connecting stub 2. To do this, the union nut 3 is pushed with the side of the clamping surface 3.2 onto the plug-in connecting stub 1.1 of the cable adapter 1 to behind the holding studs 1.3. The cable adapter 1 is inserted into the insertion opening 2.6 in the screw-on connecting stub 2 in a rotation position which can be chosen as desired relative to the screw-on connecting stub 2. During this process, the radially elastic snap-action arms 2.8 on the screw-on connecting stub 2 are bent up radially by the axial movement force of the cable adapter 1 and by the movement of the chamfer 2.9 on the snap-action arms 2.8, against the chamfer 1.12 of the plug-in connecting stub 1.1, until the snap-action arms 2.8 snap into the snap-action depression 1.2 in the plug-in connecting stub 1.1, in the completely inserted state, and produce an axial interlocking connection between the screw-on connecting stub 2 and the cable adapter 1. In the snapped-in state, it is possible to additionally align the rotation position of the cable adapter 1, since no forces are produced in the circumferential direction.

The cable gland can now be fixed in any desired rotation position of the cable adapter 1 relative to the screw-on connecting stub 2, by pushing the union nut 3 over the holding studs 1.3 on the plug-in connecting stub 1.1 and screwing it to the tightening thread 2.7 on the screw-in connecting stub 2. During this process, the clamping surface 3.2 of the union nut 3 exerts a radial clamping force on the snap-action arms 2.8 of the screw-on connecting stub 2, and produces an interlocking force-fit connection between the snap-action arms 2.8 of the screw-on connecting stub 2 and the snap-action depression 1.2 in the plug-in connecting stub 1.1 of the cable adapter 1. The sealing of this connection point is ensured by the O-ring seal 1.5.

In order to release the connection easily and without damage, the union nut 3 is unscrewed from the tightening thread 2.7 on the screw-on connecting stub 2, thus relieving the clamping force described above. The interlocking force-fit connection of the snap-action arms 2.8 to the snap-action depression 1.2, as described above, can be disconnected without damage and without any special releasing tools easily by pulling the cable adapter 1 out axially, since the snap-action arms 2.8 do not have any undercuts.

The closure screw 4 has an O-ring seal 4.1 plugged onto its thread, and is used to close and seal the cable connecting opening 1.9 by screwing the closure screw 4 into the internal thread in the cable connecting opening 1.9, when no cable connection is required for the cable gland.

By way of example FIG. 3 shows a part of a further embodiment of a cable gland according to the invention, and shows an illustration in which a cable corrugated tube 5 has been inserted into the cable connecting opening 1.9 in the cable adapter 1 and has been firmly connected to the internal thread 1.10 in the cable connecting opening 1.9 by means of an adhesive connection. The actual cable which makes the electrical connections is not illustrated. This allows the cable connection to be prefabricated, in particular allowing prefabrication of the cable corrugated tube 5 with the cable adapter 1. The cable gland according to the invention allows this prefabricated cable connection to be inserted in any desired rotation position into a screw-on connecting stub 2 which has already been fitted to an attachment housing, and to be fixed in the respective rotation position, without any additional twisting of the prefabricated cable connection, by means of the union nut 3 and the snap-action arms 2.8 on the screw-on connecting stub 2 and the snap-action depression 1.2 in the cable adapter 1.

FIG. 5 shows a detail of an electronics housing 6 having two cable glands according to the invention. The electronics housing 6 has three screw-in openings 6.1 for attaching a cable gland, in which case a cable gland according to the invention with closure screws 4 fitted is screwed into two of these screw-in openings 6.1, and another cable gland is mounted in the third, central screw-in opening 6.1.

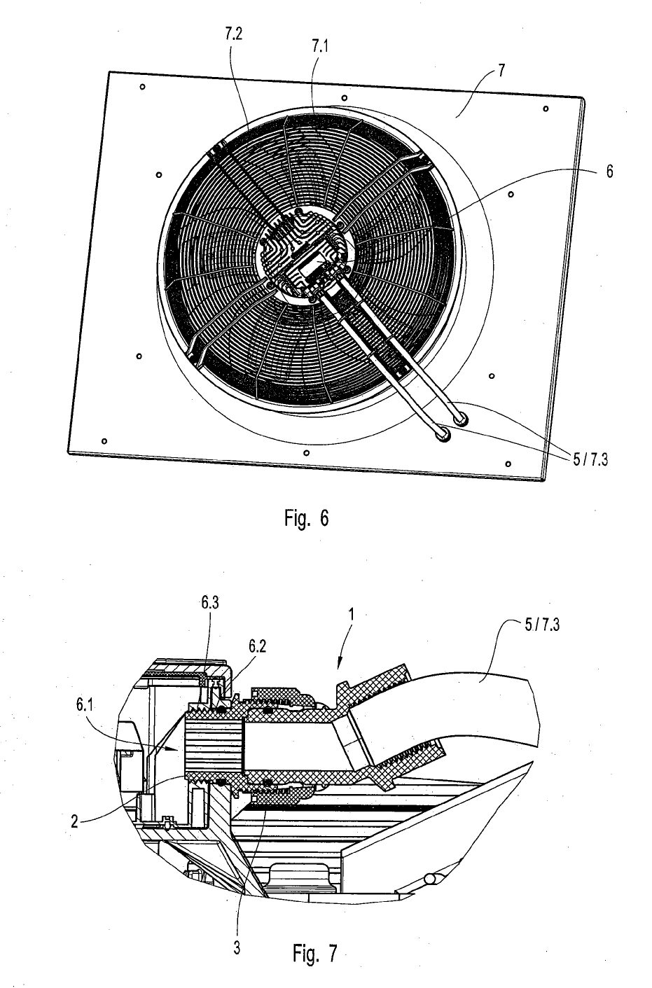

By way of example, FIG. 6 shows a ventilation unit 7 with a fan 7.1, a protective grating 7.2 and an electric motor. The electric motor has an electronics housing 6 with two cable glands according to the invention, which are connected to two connecting lines 7.3.

By way of example, FIG. 7 illustrates how a cable gland according to the invention with a corrugated tube 5 attached and with a connecting line 7.3 which is not illustrated is screwed into an electronics housing 6 according to the invention. The electronics housing 6 has a screw-in opening 6.1 with a circular-cylindrical inner sealing surface 6.2 for sealing the connection between the screw-on connecting stub 2, the cable gland and the electronics housing 6, and has an internal thread 6.3 for screwing in the cable gland with the screw-on thread 2.1. The internal thread 6.3 is located on the inner face of the electronics housing 6, relative to the sealing surface 6.2.

The invention is not restricted to the exemplary embodiments which have been illustrated and described, but also covers all embodiments with the same effect for the purposes of the invention. Furthermore, the invention has also so far not yet been restricted to the combination of features defined in the respective independent claims, but can also be defined by any desired other combination of specific features of all the individual features disclosed overall. This means that, fundamentally and in practice, any individual feature of the respective independent claim can be omitted, or can be replaced by at least one individual feature disclosed elsewhere in the application. To this extent, the claims should be understood only as an initial formulation attempt for the respective invention.

1. A cable gland for an electronics housing (6) of an electric motor, comprising a cable adapter (1) and a screw-on connecting stub (2), which can be screwed to a housing, for attachment of a cable connection, fixing means (3, 2.8) arranged on the cable adapter (1) and the screw-on connecting stub (2), for allowing in an assembly position, an axial insertion of the cable adapter (1) into the screw-on connecting stub (2) in any desired rotation position relative to one another and in an inserted state, allowing alignment of the rotation position of the cable adapter (1) relative to the screw-on connecting stub (2) and, in a fixing position, fixing the cable adapter (1) axially and in the respective relative rotation position to the screw-on connecting stub (2).

2. The cable gland as claimed in claim 1, further comprising wherein the cable adapter (1) has a housing section with a cable holding connecting stub (1.13) on one side and has a housing section with a plug-in connecting stub (1.1) on the other side, and the axes of the cable holding connecting stub (1.13) and of the plug-in connecting stub (1.1) form an angle (α)≦180°.

3. The cable gland as claimed in claim 2, further comprising wherein the plug-in connecting stub (1.1) of the cable adapter (1) has a snap-action depression (1.2) which runs on its external circumference and, on the side of its insertion opening (2.6), the screw-on connecting stub (2) has a plurality of radically elastic snap-action arms (2.8), which are distributed on its circumference as fixing means, which snap-action arms (2.8) engage in the snap-action depression (1.2) when the plug-in connecting stub (1.1) is in the inserted state, and produce an axial interlocking connection between the plug-in connecting stub (1.1) and the snap-action arms (2.8).

4. The cable gland as claimed in claim 3, further comprising wherein the fixing means is in the form of a union nut (3), which is pushed onto the plug-in connecting stub (1.1) and is screwed on by means of a tightening thread (2.7) on the screw-on connecting stub (2), which tightening thread (2.7) is located behind the snap-action arms (2.8) in the screwing-on direction, and produces an axial interlocking connection and an interlocking connection which counteracts the relative rotation between the plug-in connecting stub (1.1) and the snap-action arms (2.8) of the screw-on connecting stub (2), by means of an internal clamping surface (3.2) of the union nut (3), which clamping surface (3.2) tapers conically in the opposite direction to the screwing-on direction.

5. The cable gland as claimed in claim 4, further comprising wherein the plug-in connecting stub (1.1) has at least two holding studs (1.3) on its external circumference, which holding studs (1.3) secure the union nut (3) when the plug-in connecting stub (1.1) has not been plugged in against a sliding out from the plug-in connecting stub (1.1), by means of an interlocking connection with the clamping surface (3.2).

6. The cable gland as claimed in claim 3, further comprising wherein the snap-action arms (2.8) of the screw-on connecting stub (2) are in the form of circumferential segments (2.8), which taper conically in the direction of the insertion opening (2.6), separated by a gap and have a chamfer (2.9) at their end of the internal circumference and of the external circumference facing the insertion opening (2.6).

7. The cable gland as claimed in claim 3, further comprising wherein the plug-in connecting stub (1.1) has a centering attachment (1.7) on its outer side wall (1.6), and the screw-on connecting stub (2) has a centering depression (2.10), which matches the centering attachment on an inner side wall of the insertion opening (2.6).

8. The cable gland as claimed in claim 4, further comprising wherein the screw-on connecting stub (2) has a screw-on thread (2.1), which is bounded by a contact wall (2.5) in the direction of the tightening thread (2.7), on its external circumference on the side facing away from the insertion opening (2.6).

9. The cable gland as claimed in claim 8, further comprising wherein the screw-on connecting stub (2) is provided on its internal circumference of the through-opening in the area of the screw-on thread (2.1) with an internal polygonal contour (2.2) as an internal force action point.

10. The cable gland as claimed in claim 3, further comprising wherein the plug-in connecting stub (1.1) has a circumferential groove (1.4), which runs on its external circumference and has an O-ring seal (1.5), between the snap-action depression (1.2) and the side wall (1.6).

11. The cable gland as claimed in claim 8, further comprising wherein the screw-on connecting stub (2) has a circumferential groove (2.3), which runs on its external circumference and has an O-ring (2.4), between the screw-on thread (2.1) and the contact wall (2.5).

12. The cable gland as claimed in claim 1, further comprising wherein a cable connecting opening (1.9), which has an internal thread (1.10) in its internal circumference, and a closure screw (4) with an O-ring seal (4.1), which closes the cable connecting opening (1.9) of the cable adapter (1).

13. The cable gland as claimed claim 12, further comprising wherein a corrugated tube (5) is firmly connected to the cable connecting opening (1.9) by means of an adhesive joint.

14. The cable gland as claimed in claim 1, further comprising wherein the cable gland is produced from plastic.

15. An electronics housing (6) of an electric motor, comprising an assembled cable gland in accordance with claim 1.

16. The cable gland as claimed in claim 3, further comprising wherein the plug-in connecting stub (1.1) on the cable adapter (1) is inserted into the insertion opening (2.6) in the screw-on connecting stub (2).

17. The cable gland as claimed in claim 2, further comprising wherein a cable corrugated tube (5) can be inserted into a cable connecting opening (1.9) in the cable connecting stub (1.13) of the cable adapter (1).

18. The cable gland as claimed in claim 17, further comprising wherein the cable corrugated tube (5) is adhesively bonded in the cable connecting opening (1.9) in the cable connecting stub (1.13) of the cable adapter (1).

19. A cable connection comprising a cable adapter (1) and a screw-on connecting stub (2) which can be screwed to a housing, and a cable corrugated tube (5) which is inserted into the cable adapter (1), wherein fixing means (3, 2.8) are arranged on the cable adapter (1) and on the screw-on connecting stub for allowing, in an assembly position, an axial insertion of the cable adapter (1) into the screw-on connecting stub (2) in any desired rotation position relative to one another and, and in an inserted state, allowing alignment of the rotation position of the cable adapter (1) relative to the screw-on connecting stub (2) and, in a fixing position, fixing the cable adapter (1) axially and in the respective relative rotation position to the screw-on connecting stub (2).

20. The cable connection as claimed in claim 19, further comprising wherein the cable corrugated tube (5) is adhesively bonded in the cable connecting opening (1.9) in the cable connecting stub (1.13) of the cable adapter (1).
